(19) United States
(12) Patent Application Publication
(10) Pub. No.: US 2024/0422134 A1
(43) Pub. Date: Dec. 19, 2024

(54) EVENT-TRIGGERED EARMARKING VIA AN ENCRYPTED SESSION OF A CREDENTIALED SYSTEM

(71) Applicant: Truist Bank, Charlotte, NC (US)

(72) Inventor: Benjamin Adelman, Charlotte, NC (US)

(73) Assignee: Truist Bank, Charlotte, NC (US)

(21) Appl. No.: 18/334,049

(22) Filed: Jun. 13, 2023

(51) Int. Cl. H04L 9/40

(52) U.S. Cl. CPC H04L 63/0428; H04L 63/102; H04L 63/107

(57) ABSTRACT

Systems and methods for earmarking via an encrypted session of a credentialed system identify an event associated with a threshold ratio, the event enabling a user to qualify for one or more previously inaccessible earmarking capabilities and triggering notification(s) to be issued via a credentialed system. Further, systems and methods determine that the user inputs security credential(s) to access the encrypted session of the credentialed system associated with the user, and transmit, via the credentialed system, notification(s) to be displayed via a user interface of a user device being used to access the credentialed system that indicate the user qualifies for the one or more previously inaccessible earmarking capabilities. An input is received, by the credentialed system via a user interface, from the user indicating an intention to earmark resource(s), the earmarking including allocating the resource(s) to a credentialed location specific to the user and associated with the credentialed system.

### FIELD OF THE INVENTION

This invention relates generally to the field of earmarking, and more particularly embodiments of the invention relate to earmarking via an encrypted session of a credentialed system.

### BACKGROUND OF THE INVENTION

A credentialed system may include a structured framework designed to verify and validate the qualifications of individuals in order to access certain information. By implementing a credentialed system, organizations can ensure that only specific individuals access the information. One key aspect of a credentialed system is the establishment of specific criteria and requirements in order to obtain access to the credentialed system. Specifically, a credentialed system incorporates authentication methods used to authenticate an individual. Authentication methods may vary depending on the capabilities of the computing environment, and in some cases can include multi-step authentication. Once an individual successfully provides credentials that can be used to authenticate the individual, the user may be provided access to information of the credentialed system. When an individual is provided access to information of the credentialed system, any communication or exchange of information provided via the credentialed system is protected via an encrypted session. An encrypted session or channel uses encryption algorithms and keys to ensure that only authorized parties can access and understand the information being access or exchanged by converting data into an unreadable format during data transmission, thereby thwarting any third party's ability to decipher the content of the information.

Such credentialed systems are often used to perform various tasks, but oftentimes individuals may not be aware of all of the options available via the credentialed system to utilize various resources. Thus, a need exists for improved systems and methods for earmarking via an encrypted session of a credentialed system.

### BRIEF SUMMARY

Shortcomings of the prior art are overcome and additional advantages are provided through the provision of a computing system for event triggered earmarking via an encrypted session of a credentialed system. The system includes at least one processor, a communication interface communicatively coupled to the at least one processor, and a memory device storing executable code. When the executable code is executed, it causes the at least one processor to, at least in part, identify an event associated with a threshold ratio, wherein the event enables a user to qualify for one or more previously inaccessible earmarking capabilities, the event triggering at least one notification to be issued via a credentialed system. Further, the executable code causes the at least one processor to determine that the user inputs one or more security credentials to access the encrypted session of the credentialed system associated with the user. In addition, the at least one notification is transmitted, via the credentialed system, to a user device being used to access the credentialed system, the at least one notification to be displayed via a user interface of the user device, the at least one notification indicating that the user qualifies for the one or more previously inaccessible earmarking capabilities. The executable code further causes the at least one processor to receive, by the credentialed system and via a user interface, an input from the user indicating an intention to earmark one or more resources, wherein the input is received by the user device as plaintext, encrypted and transmitted across the network via encoded ciphertext, the earmarking including allocating the one or more resources to a credentialed location specific to the user and associated with the credentialed system.

Additionally, disclosed herein is a computing system for earmarking via an encrypted session of a credentialed system. The system includes at least one processor, a communication interface communicatively coupled to the at least one processor, and a memory device storing executable code that, when executed, causes the at least one processor to, at least in part, determine that a user inputs one or more security credentials to access the encrypted session of the credentialed system associated with the user. Further, at least one notification is transmitted, via the credentialed system, to a user device being used to access the credentialed system, the at least one notification to be displayed via a user interface of the user device, the at least one notification indicating one or more earmarking capabilities not currently utilized by the user. Further, an input is received, by the credentialed system and via a user interface, from the user indicating an intention to earmark one or more resources, wherein the input is received by the user device as plaintext, encrypted and transmitted across the network via encoded ciphertext, the earmarking including allocating the one or more resources to a credentialed location specific to the user and associated with the credentialed system.

Also disclosed herein is a computer-implemented method for event triggered earmarking via an encrypted session of a credentialed system. The computer-implemented method includes, at least in part, identifying an event associated with a threshold ratio, wherein the event enables a user to qualify for one or more previously inaccessible earmarking capabilities, the event triggering at least one notification to be issued via a credentialed system. The method also includes determining that the user inputs one or more security credentials to access the encrypted session of the credentialed system associated with the user. In addition, the method includes transmitting, via the credentialed system, the at least one notification to a user device being used to access the credentialed system, the at least one notification to be displayed via a user interface of the user device, the at least one notification indicating that the user qualifies for the one or more previously inaccessible earmarking capabilities. An input is received, by the credentialed system and via a user interface, from the user indicating an intention to earmark one or more resources, wherein the input is received by the user device as plaintext, encrypted and transmitted across the network via encoded ciphertext, the earmarking including allocating the one or more resources to a credentialed location specific to the user and associated with the credentialed system.

The features, functions, and advantages that have been described herein may be achieved independently in various embodiments of the present invention including computer-implemented methods, computer program products, and computing systems or may be combined in yet other embodiments, further details of which can be seen with reference to the following description and drawings.

### BRIEF DESCRIPTION

One or more aspects are particularly pointed out and distinctly claimed as examples in the claims at the conclusion of the specification. The foregoing as well as objects, features, and advantages of one or more aspects are apparent from the following detailed description taken in conjunction with the accompanying drawings in which:

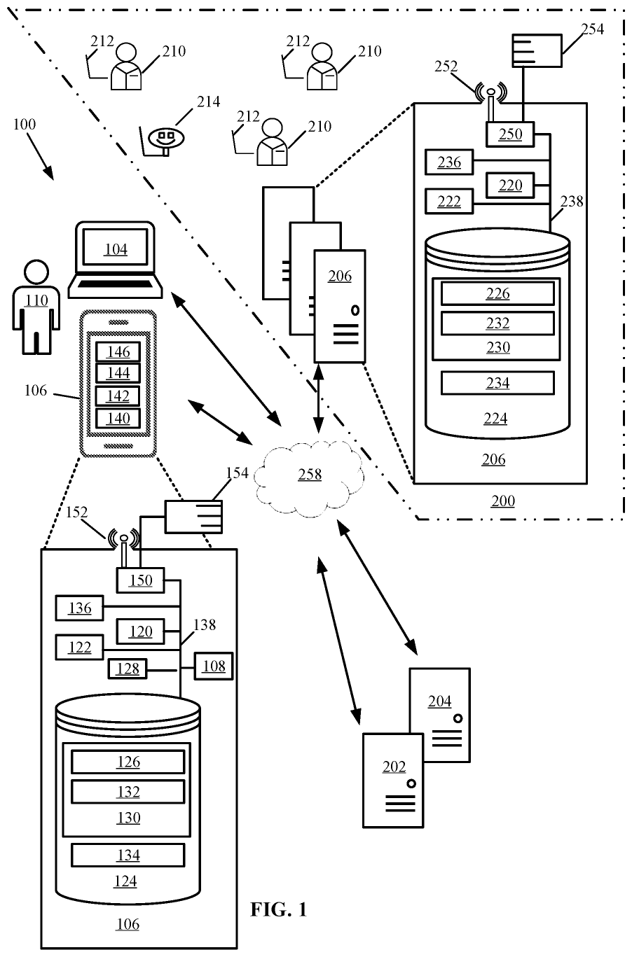

FIG. 1 illustrates an example computing environment for earmarking via an encrypted session of a credentialed system, in accordance with an embodiment of the present invention;

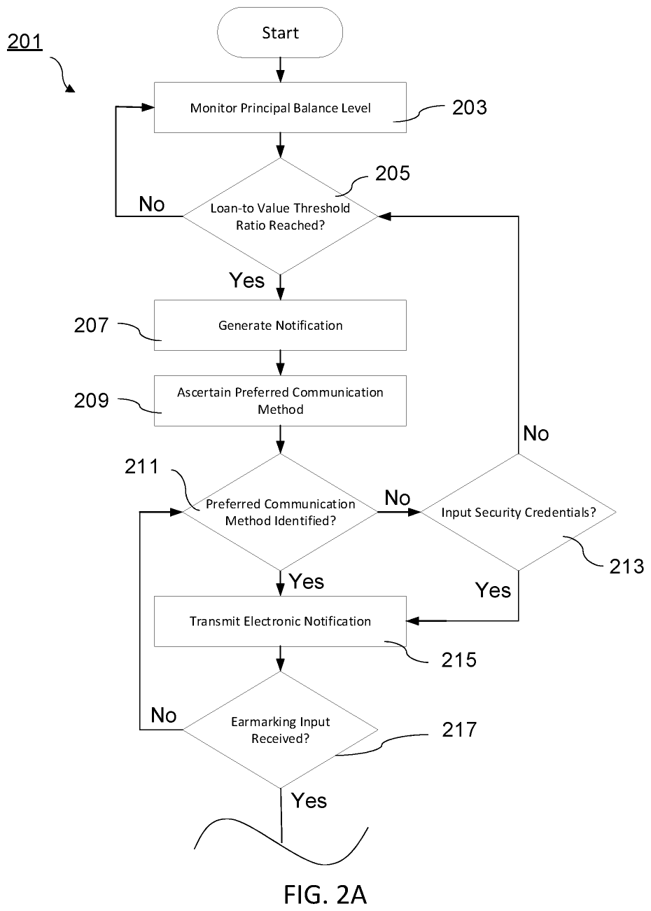

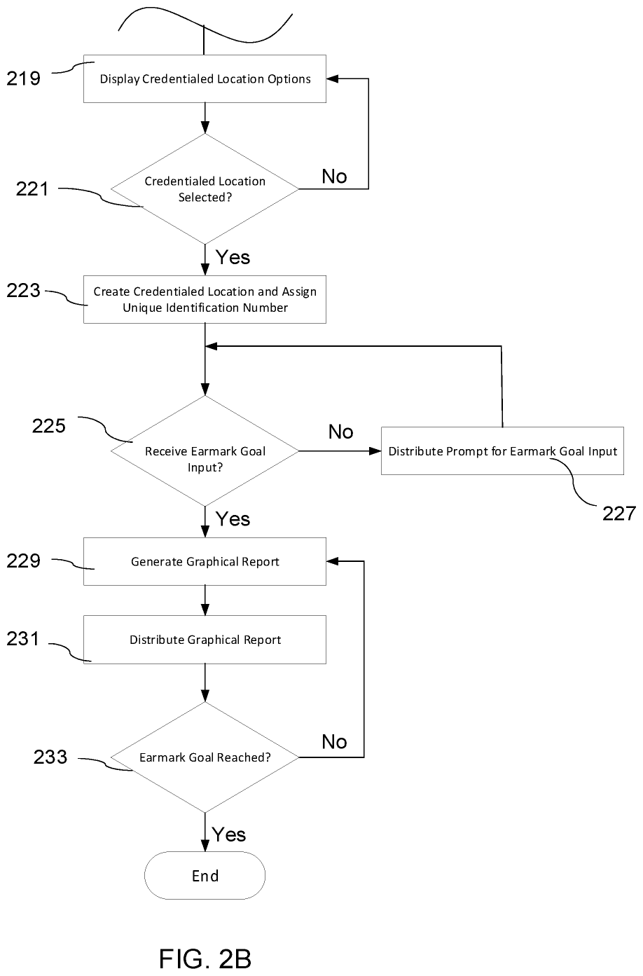

FIG. 2A depicts portions of an example process flow for earmarking via an encrypted session of a credentialed system, in accordance with an embodiment of the present invention;

FIG. 2B depicts additional portions of the example process flow of FIG. 2A, in accordance with an embodiment of the present invention;

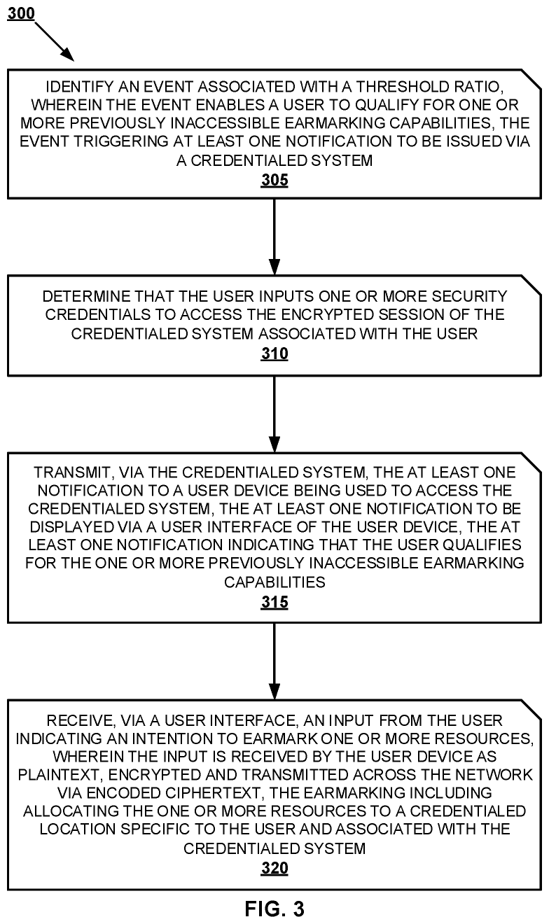

FIG. 3 depicts a block diagram of an example method for event triggered earmarking via an encrypted session of a credentialed system, in accordance with an embodiment of the present invention; and

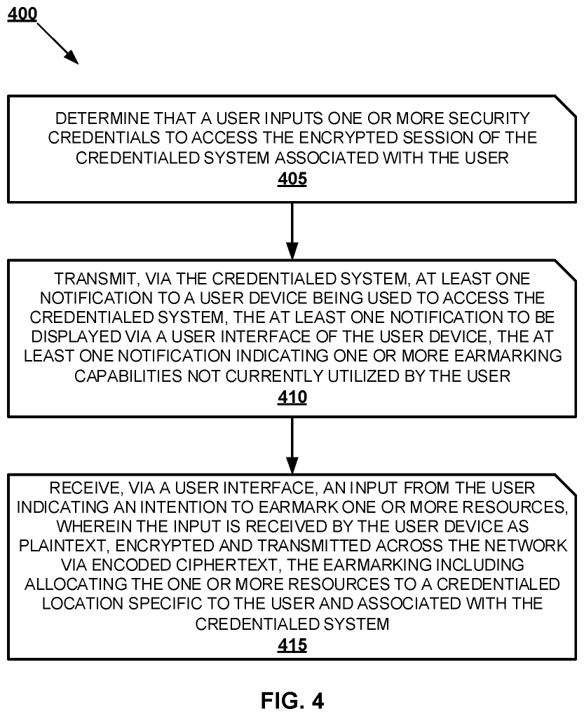

FIG. 4 depicts a block diagram of an example method for earmarking via an encrypted session of a credentialed system, in accordance with an embodiment of the present invention.

### DETAILED DESCRIPTION

Aspects of the present invention and certain features, advantages, and details thereof are explained more fully below with reference to the non-limiting examples illustrated in the accompanying drawings. It is to be understood that the disclosed embodiments are merely illustrative of the present invention and the invention may take various forms. Further, the figures are not necessarily drawn to scale, as some features may be exaggerated to show details of particular components. Thus, specific structural and functional details illustrated herein are not to be interpreted as limiting, but merely as a representative basis for teaching one skilled in the art to employ the present invention.

Descriptions of well-known processing techniques, systems, components, etc. are omitted to not unnecessarily obscure the invention in detail. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

The specification may include references to “one embodiment,” “an embodiment,” “various embodiments,” “one or more embodiments,” etc. may indicate that the embodiment(s) described may include a particular feature, structure or characteristic, but every embodiment may not necessarily include the particular feature, structure, or characteristic. In some cases, such phrases are not necessarily referencing the same embodiment. When a particular feature, structure, or characteristic is described in connection with an embodiment, such description can be combined with features, structures, or characteristics described in connection with other embodiments, regardless of whether such combinations are explicitly described. Thus, unless described or implied as exclusive alternatives, features throughout the drawings and descriptions should be taken as cumulative, such that features expressly associated with some particular embodiments can be combined with other embodiments.

Like numbers refer to like elements throughout. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “couple,” “coupled,” “couples,” “coupling,” “fixed,” “attached to”, and the like should be broadly understood to refer to connecting two or more elements or signals electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant. “Communicatively coupled to” and “operatively coupled to” can refer to physically and/or electrically related components.

In addition, as used herein, the terms “about”, “approximately”, or “substantially” for any numerical values or ranges indicate a suitable dimensional tolerance that allows the device, part, or collection of components to function for its intended purpose as described herein.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code can include both software and hardware. For example, program code in certain embodiments of the present invention can include fixed function hardware, while other embodiments can utilize a software-based implementation of the functionality described. Certain embodiments combine both types of program code.

As used herein, the terms “enterprise” or “provider” generally describes a person or business enterprise that hosts, maintains, or uses computer systems that provide functionality for the disclosed systems and methods. In particular, the term “enterprise” may generally describe a person or business enterprise providing goods or services. Interactions between an enterprise system and a user device can be implemented as an interaction between a computing system of the enterprise, and a user device of a user. For instance, user(s) may provide various inputs that can be interpreted and analyzed using processing systems of the user device and/or processing systems of the enterprise system. Further, the enterprise computing system and the user device may be in communication via a network. According to various embodiments, the enterprise system and/or user device(s) may also be in communication with another external or third party server of a third party system that may be used to perform one or more server operations. In some embodiments, the functions of one illustrated system or server may be provided by multiple systems, servers, or computing devices, including those physically located at a central computer processing facility and/or those physically located at remote locations.

Embodiments of the present invention are described herein, with reference to flowchart illustrations and/or block diagrams of computer-implemented methods and computing systems according to embodiments of the invention. Each block of the flowchart illustrations and/or block diagrams, and combinations of blocks in the flowchart illustrations and/or block diagrams, can be implemented by computer readable program instructions that may be provided to a processor of a general purpose computer, special purpose computer, or other programmable data processing apparatus or apparatuses (the term “apparatus” includes systems and computer program products). In particular, the computer readable program instructions, which be executed via the processor of the computer or other programmable data processing apparatus, create a means for implementing the functions/acts specified in the flowchart and/or block diagram block or blocks.

In one embodiment, these computer readable program instructions may also be stored in one or more computer-readable storage media that can direct a computer or other programmable data processing apparatus, and/or other devices, to function in a particular manger, such that a computer readable storage medium of the one or more computer-readable storage media having instructions stored therein comprises an article of manufacture including instructions which implement aspects of the actions specified in the flowchart illustrations and/or block diagrams. In particular, the computer-readable program instructions may be used to produce a computer-implemented method by executing the instructions to implement the actions specified in the flowchart illustrations and/or block diagram block or blocks.

In another embodiment, these computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions, whether stored in the computer-readable storage medium and/or computer-readable memory may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

In the flowchart illustrations and/or block diagrams disclosed herein, each block in the flowchart/diagrams may represent a module, segment, a specific instruction/function or portion of instructions/functions, and incorporates one or more executable instructions for implementing the specified logical function(s). Additionally, the alternative implementations and processes may also incorporate various blocks of the flowcharts and block diagrams. For instance, in some implementations the functions noted in the blocks may occur out of the order noted in the figures. For example, two blocks shown in succession may be executed substantially concurrently, or the functions of the blocks may sometimes be executed in the reverse order, depending upon the functionality involved.

FIG. 1 illustrates a computing environment 100 that facilitates earmarking via an encrypted session of a credentialed system, according to at least one embodiment of the present invention. The computing environment 100 generally includes a user 110 (e.g., an employee of an enterprise) that benefits through use of services and products offered by the enterprise system 200. The computing environment 100 may include, for example, a distributed cloud computing environment (private cloud, public cloud, community cloud, and/or hybrid cloud), an on-premise environment, fog-computing environment, and/or an edge-computing environment. The user 110 accesses services and products of the enterprise system 200 by use of one or more user devices, illustrated in separate examples as 104, 106. Example user devices 104, 106 may include a laptop, desktop computer, tablet, a mobile computing device such as a smart phone, a portable digital assistant (PDA), a pager, a mobile television, a gaming device, an audio/video player, a virtual assistant device or other smart home device, a wireless personal response device, or any combination of the aforementioned, or other portable device with processing and communication capabilities.

In the illustrated example, the mobile device 106 is illustrated in FIG. 1 as having exemplary elements, the below descriptions of which apply as well to the computing device 104. The user device 104, 106 can include integrated software applications that manage device resources, generate user interfaces, accept user inputs, and facilitate communications with other devices among other functions. The integrated software applications can include an operating system, such as Linux®, UNIX®, Windows®, macOS®, iOS®, Android®, or other operating system compatible with personal computing devices. Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system used on personal computers, central computing systems, phones, and other devices.

The user 110 can be any individual, a group, entity, etc. that is in possession of or has access to the user device 104, 106, which may be personal or public items. Although the user 110 may be singly represented in some figures, in at least in some embodiments the user 110 is one of many such that a group of users through multiple user devices utilize the computing environment 100 to communicate with the enterprise system 200.

The user device 104, 106, but as illustrated with reference to the mobile device 106, includes components such as, at least one of each of a processor 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processor 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user, or required or related to any or all of the applications or programs 130.

The memory device 122 is operatively coupled to the processor 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory additionally or alternatively can include an electrically erasable programmable read-only memory (EEPROM), flash memory or the like.

According to various embodiments, the memory device 122 and storage device 124 may be combined into a single storage medium. The memory device 122 and storage device 124 can store any of a number of applications that comprise computer-executable instructions and code executed by the processing device 120 to implement the functions of the user device 104, 106 described herein. For example, the memory device 122 may include such applications as a conventional web browser application and/or an enterprise-distributed application (e.g., a mobile application), collectively referred to herein as a “web portal”. These applications also typically provide a graphical user interface (GUI) on the display 140 that allows the user 110 to communicate via the user device 104, 106 with, for example, an enterprise system 200, and/or other devices or systems. For instance, the GUI on the display 140 may include features for displaying information and accepting inputs from users, and may include fillable text boxes, data fields, hyperlinks, pull down menus, check boxes, and the like.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices may include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices of the input and output system 136 may include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

According to one embodiment, the input and output system 136 may include an optical instrument (e.g., camera 146) configured to capture an image. For instance, the optical instrument may include one or more lenses and one or more image sensors (e.g., a charge coupled device (CCD) sensor) configured to convert photons into an electrical signal. For example, pixels of each the image sensors may each include a photodiode (e.g., a semiconductor) that becomes electrically charged in accordance with the strength of the light that strikes the photodiode, where the electrical charge is then relayed to be converted to an electrical signal. In one embodiment, a series of pulses may be applied to the one or more image sensors to relay the accumulate charges within each photodiode in succession down a row of photodiodes to an edge of the respective image sensor. Other optical instrument functionalities are also contemplated herein.

In one embodiment, the input and output system 136 may also be configured to obtain and process various forms of authentication to obtain authentication information of a user 110 in order to provide, for example, access to a specific web portal of the enterprise system 200. For instance, the web portal may be accessed based on the user providing authentication information to log in to the web portal in order to perform various functionalities described herein. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a predetermined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a Global Positioning System (GPS) configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138 (e.g., system bus), connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, short message service (SMS), enterprise messaging service (EMS), multimedia messaging service (MMS) messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS may be included for navigation and location-related data exchanges, ingoing and/or outgoing. Communications may also or alternatively be conducted via the connector 154 for wired connections such as by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

Computing environment 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, a single system or server may provide the functions of one or more systems, servers, or illustrated components. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210 can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more human agents 210, and as an input device by providing virtual buttons, selectable options, a virtual keyboard, and other indicia that, when touched or activated, control or prompt the agent device 212 by action of the human agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

The computing system 206 may have various components similar to the user device 104, 106. For instance, in one example the computing system 206 may include at least one of each of a processing device 220, and a memory device 222 for use by the processing device 220, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data and files, such as those for user accounts, user profiles, enterprise data, files downloaded or received from other devices, and other data items preferred by the user and/or enterprise or required or related to any or all of the applications or programs 230.

As illustrated, the computing system 206 includes an input/output system 236, which generally refers to, includes, and/or is operatively coupled with agent devices 212 and automated system(s) 214, as well as various other input and output devices. According to various embodiments, the computing system 206 may be used to distribute the digital data collection program as, for example a Software-as-a-Service (SaaS) that can be accessed by the user device 104, 106 on a subscription basis via a web browser or mobile application. SaaS may provide a user 110 with the capability to use applications running on a cloud infrastructure of the enterprise system 200, where the applications are accessible using the user device 104, 106 via a thin client interface such as a web browser and the user 110 is not permitted to manage or control the underlying cloud infrastructure (i.e., network, servers, operating systems, storage, or specific application capabilities that are not user-specific) of the enterprise system 200.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device 104, 106.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, near-field communication device, and other transceivers. In addition, GPS may be included for navigation and location-related data exchanges, ingoing and/or outgoing. Communications may also, or alternatively, be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing system 206, may be or include a workstation, a server, or any other suitable device, including a set of servers, a cloud-based application or system, or any other suitable system, adapted to execute, for example any suitable operating system, including Linux, UNIX, Windows, macOS, IOS, Android, and any known other operating system used on personal computer, central computing systems, phones, and other devices.

The user devices 104, 106, the agent devices 212, computing system 206, which may be one or any number centrally located or distributed, are in communication through one or more networks, referenced as network 258 in FIG. 1.

The network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of this description. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMAX, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, frames using frame relay, voice, video, data, and other suitable information between network addresses. The network 258 may also include one or more local area networks (LANs), radio access networks (RANs), metropolitan area networks (MANs), wide area networks (WANs), personal area networks (PANs), WLANs, campus area network (CAN), storage-area network (SAN), all or a portion of the internet and/or any other communication system or systems at one or more locations.

The network 258 may incorporate a cloud platform/data center that support various service models including Platform as a Service (PaaS), Infrastructure-as-a-Service (IaaS), and Software-as-a-Service (SaaS). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public). In one particular embodiment, the network 258 includes Amazon Web Services (AWS) cloud computing platform.

Two external systems 202 and 204 are expressly illustrated in FIG. 1, representing any number and variety of data sources, users, consumers, customers, third-party PaaS, third-party IaaS, external databases, business entities, banking systems, enterprises, organizations, institutions, companies, government entities, clubs, and groups of any size are all within the scope of the description. According to various embodiments, external systems 202 and 204 may utilize software applications that function using external resources that are available through a third-party provider such as SaaS, PaaS, or IaaS service models. Such external systems 202, 204 include the third party systems accessible via the agent devices 212 using a software application (e.g., an integrated mobile software application or an application-programming interface (API) software application) that can be integrated with the computing system 206 to facilitate communication between software and systems and configured to utilize different data formats between systems. In another embodiment, the third party system may be accessible by the agent devices 212 using a web-based software interface (e.g., a website).

In certain embodiments, one or more of the systems described herein such as the user device (referring to either or both of the computing device 104 and the mobile device 106), the enterprise system 200, and/or the external systems 202 and 204 are, include, or utilize virtual resources. Such virtual resources are or include cloud resources or virtual machines. The virtual resources may utilize a cloud-computing configuration to provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud-computing configuration so that the resources may be shared as needed.

Financial institutions that service mortgage loans typically utilize a credentialed system to ensure that only authorized users have access to information related to the mortgage loans. However, oftentimes authorized users may not be aware of all of the options available to them via the credentialed system that would enable those users to obtain better services and functionalities. In some instances, particularly with clients that have mortgages, individuals may not be aware that private mortgage insurance (“PMI”) can be canceled once their loan-to-value ratio (“LTV”) hits 80%. PMI is a tool often utilized by homebuyers that are unable or choose not to provide a down payment of at least 20% to obtain mortgage financing at a lower rate. Specifically, PMI protects lenders from the risk of default and foreclosure and provides the lender with a mechanism to recover certain losses associated with the resale of a foreclosed property. In general, if a borrower is able to provide a down payment of at least 20%, PMI coverage provides little extra protection for a lender and does not benefit the borrower. Because of this limited benefit to the borrower, and the lack of uniformity related to processes for canceling PMI once a borrower's equity reached 20%, the Homeowners Protection Act (“Act”) was established to protect homeowners by establishing uniform procedures for the cancellation and termination of PMI policies. This Act requires the mortgage servicer to cancel PMI when a non-high risk borrower submits a written request to the servicer and the principal balance of the loan reaches or is first scheduled to reach 80% of the original value of the residential unit and various other conditions are met. Further, the Act requires a mortgage servicer to automatically terminate PMI for non-high-risk residential mortgages when the principal balance of the mortgage is first scheduled to reach 78% of the original value of the secured property if the borrower is current on payments or on the first day of the month following the date the borrower becomes current on payments.

However, some borrowers may not be aware that they can cancel their PMI payments once the principal balance of the mortgage reaches 80% or such borrowers may not be aware that they have reached the 80% threshold. Thus, the borrowers may still maintain PMI until the 78% threshold is reached in order to trigger automatic termination. In other instances, due to a “high risk” classification of the loan, the automatic termination may not apply and borrowers may not be aware of when they have become qualified to cancel their PMI. Further, borrowers may also not be aware that automatic escrow payments for taxes and insurance can be optional once their equity has reached the 80% threshold. While automatic escrow payments for taxes and insurance may be viewed as a benefit for some customers, generally financial institutions do not pay interest on money held in escrow accounts. Thus, some customers may choose to cancel their automatic escrow account and move their money into a savings account with an interest rate, which can provide a financial benefit to customers. However, customers may not be aware that they can cancel their automatic escrow account, that there are alternative options that may provide a financial benefit, or when they would be eligible to cancel their automatic escrow account. Further, one hesitation customers may have to canceling their automatic escrow account is that they are afraid of losing track of how much money needs to be set aside or they may be like the automatic nature of the automatic self-escrow account. In order to overcome this obstacle, an automated self-escrow account that the borrower sets up that is interest bearing, that automatically sets aside the amount needed to fund taxes and insurance, and that provides instructions and reminders to the borrower about whether they are setting aside sufficient funds or if they need to adjust the amount being set aside would be beneficial.

A need exists for improved methods for educating customers and providing customers with current information about what options are available to them when their principal balance of the mortgage reaches 80%. By providing proactive education to customers, financial institutions can foster loyalty and trust, and can educate customers on potential financial benefits available to them. Advantageously, the disclosed systems and processes integrate these processes into a practical application by receiving at a first computing device (such as user devices 104, 106), via a user interface, inputs (e.g., a plain text input) indicating an intention to earmark one or more resources, and the one or more processors and transform those inputs to ciphertext word signal using cryptographic mathematical models (i.e., algorithms) and transmits the ciphertext word signal, via a communication channel such as a network (e.g. network 258), to a second credentialed computing system (e.g. computing system 206) where a processing device (e.g., processing device 220) decrypts the ciphertext word signal using an algorithm that transforms the ciphertext back into plaintext. The earmarking includes allocating the one or more resources to a credentialed location, such as a credentialed storage location that is specific to the user. Thus, the various algorithms and mathematical formulas used to encrypt user inputs indicating an intention to earmark one or more resources are used in a specific manner that sufficiently limits the use of the mathematical concepts to the practical application of transmitting the ciphertext word signals to a computer system over a communication channel. The mathematical concepts associated with encryption and decryption are integrated into a process that secures private network communications so that ciphertext word signals can be transmitted between computers or computer systems of customers and financial institutions.

FIGS. 2A and 2B depict an example process flow 201 for earmarking via an encrypted session of a credentialed system, according to one embodiment. At block 203 a credentialed computing system (e.g., computing system 206) monitors a principal balance level owed by a borrower (e.g., a mortgagor) and at step 205 compares that principal balance to the purchase price of the property (e.g., a residential unit). The computing system (e.g., computing system 206) then determines whether a loan-to-value threshold ratio, which is typically 80%, is reached. If the loan-to-value threshold ratio is too high, e.g., more than 80%, then the computing system (e.g., computing system 206) reverts back to block 203 and continues to monitor the principal balance level. However, if the predetermined loan-to-value threshold is reached, which is typically 80%, then the process moves on to step 207 where the computing system (e.g., computing system 206) generates a notification to be distributed to the borrower (e.g., a mortgagor). The notification can be a standard notification that would not need to be encrypted or the notification may be a customized notification that identifies exactly what options are available to the borrower to establish a self-escrow account. For instance, one example notification that may be generated may indicate exactly what interest rate the borrower would be eligible to receive via the self-escrow account, what the total financial benefit would be to the borrower based on the amount that the borrower is predicted to set aside as part of the self-escrow in order to adequately fund taxes and home insurance payments, the approximate dates that the customer would need to make payments towards taxes and insurance, indicate the steps needed to set up the self-escrow account, indicate that the borrower is now eligible to cancel their PMI coverage, and/or steps needed to cancel their PMI coverage.

At step 209, the credentialed system then ascertains a saved preferred communication method of the borrower. For instance, the borrower may have saved communication preferences indicating that they prefer SMS text communication, email communication, no marketing-related communication, etc. At step 211, the credentialed system determines whether the borrower has indicated a preferred communication method that allows for marketing-related communication, then at step 215 the credentialed system transmits the electronic notification (e.g., via SMS text, email, automated phone call, etc.) to a user device. In some instances, depending upon the communication method used, the electronic notification may need to be encrypted and sent as encoded ciphertext in order to be transmitted across a network.

If the borrower has indicated that they do not want to receive marketing-related communication, via text, phone, email, etc., or if those methods of communication are not available, the credentialed system may postpone transmittal of the notification until the borrower inputs security credentials, at step 213, to log in to the credentialed system via a website of the financial institution. If the borrower does not input security credentials, then the system would continue to compare the principal balance level to the loan-to-value threshold to determine whether the 78% threshold is reached in order to trigger automatic termination of the PMI. Alternatively, if the borrower does log in to the credentialed system and the credentialed system does, at step 213, identify security credentials then an electronic notification is transmitted at step 215. In some instances, depending upon the communication method used, the electronic notification may need to be encrypted and sent as encoded ciphertext in order to be transmitted across a network.

At step 217, the credentialed system determines whether an earmarking input has been received from a user via a user device. For instance, the notification may include a link to allow the customer to access the credentialed system in order to set up an earmarking program to allocate financial resources to a credentialed self-escrow account that is specific to the user and associated with the credentialed system. When the customer clicks the link and logs in to the credentialed system, the credentialed system receives an earmarking input. If no earmarking input is received at step 217, the credentialed system may revert to identifying the preferred communication method and transmitting additional electronic notifications (e.g., daily, weekly, bi-weekly, etc.).

At block 219, the credentialed system automatically displays, via a user interface of the user device (e.g., user devices 104, 106), credentialed location options to the customer once the customer has provided the intention to earmark one or more resources by providing the earmarking input (e.g., selecting the link and/or providing plaintext to log in to the earmarking page via the website) in response to the notification. The credentialed location options may include an interest bearing self-escrow account that the customer can sign up for in order to earn interest on the amount being set aside each pay period for taxes and insurance. In some embodiments, the credentialed location options may include a self-designated interest bearing escrow account specifically for property taxes, a separate interest bearing escrow account specifically for property insurance, a separate interest bearing escrow account specifically for home repairs, utilities, home upgrades, etc., or the credentialed location options may have a single account where the customer can combine funds for multiple upcoming expenses. The credentialed system may then determine, at step 221, whether the customer has selected a credentialed location an interest bearing self-escrow savings account) to deposit financial resources. If no credentialed location is selected, then the credentialed system may continue to display credentialed location options that may be the same or different from those previously displayed.

At block 223, once the user selects a credentialed location and indicates that they want to open an interest bearing self-escrow savings account, the credentialed system may create a credentialed location such as the interest bearing self-escrow savings account and assign that credentialed location a unique identification/account number. The credentialed system may then display, via the user interface, control inputs so that the customer can indicate an earmark goal, and at step 225, the credentialed system may determine whether an earmark goal input is received. Example control inputs may include, according to various embodiments, checkboxes, radio buttons, toggle buttons, switches, text inputs, dropdown buttons, floating action buttons, menu buttons, expandable buttons, raised buttons, call-to-action buttons, text buttons, ghost buttons, and/or various other interactive elements of the user interface through which the user may enter information into the system's interface. If the customer does not indicate, via the control inputs, an earmark goal, the credentialed system may distribute, at block 227, a prompt for the user to provide an earmark goal input. An earmark goal input may include, for example, an amount that the customer wants to set aside in their interest-bearing self-escrow account in order to ensure that they have enough money available to pay their property taxes, property insurance, and/or other expenses. Further, the earmark goal input may indicate an approximate date when that amount needs to be available, the way in which the funds should be allocated to the interest-bearing self-escrow account (e.g., automatic deduction from direct deposit), the frequency of deposits to the interest-bearing self-escrow account, a flat withdrawal schedule of funds (e.g., via automatic deduction from direct deposit), an accelerated withdrawal schedule (e.g., smaller initial withdrawals with increasing amounts the closer to the due date, higher amounts withdrawn during alternate pay periods to account for other expenses, etc.).

At block 229, the credentialed system may periodically generate a graphical report on whether a customer is meeting their earmark goal, whether the customer has dipped into the interest-bearing self-escrow account and needs to increase the amount being set aside, or whether the customer has allocated more than needed to reach the earmark goal and can reduce the amount being allocated to the interest-bearing self-escrow account. At block 231, the graphical report may be distributed to customers (e.g., via an SMS text, an email, a push notification, etc.). At step 233, the credentialed system determines whether the customer has reached their earmark goal, at which point the process ends, or if the goal has not been achieved, the credentialed system continues to periodically generate a new graphical report at block 229 until the earmark goal is reached.

FIG. 3 depicts a block diagram of an example method 300 for event triggered earmarking via an encrypted session of a credentialed system, in accordance with an embodiment of the present invention. In this example, at block 305 the credentialed computer system of an enterprise system identifies an event associated with a threshold ratio. The event may include, for example, an equity value of real property reaching at least twenty percent. In other embodiments, the event may include an equity value of real property reaching at least twenty-two percent if, for example, the customer has not opted out of PMI and the PMI automatically ends once the principal balance of the mortgage reaches 78% of the original value of the residential unit. Various other events associated with a threshold ratio may also be identified. In particular, the event enables the user to qualify for one or more previously inaccessible earmarking capabilities. The earmarking capabilities may include an interest-bearing self-escrow account that the user would not have been eligible to select prior to the threshold ratio being reached. In one non-limiting example, the earmarking capabilities would not have been accessible to the user while the user was required to be enrolled in PMI. Further, the event may trigger at least one notification to be issued via a credentialed system. At block 310, the credentialed system determines that the user inputs one or more security credentials to access the encrypted session of the credentialed system associated with the user.

At block 315, the credentialed system transmits, the at least one notification to a user device being used to access the credentialed system, the at least one notification to be displayed, via a user interface of the user device. Further, the at least one notification that is transmitted indicates that the user qualifies for the one or more previously inaccessible earmarking capabilities. At block 320, the credentialed system receives, across a network via a user interface of the user device, an input from the user that indicates an intention to earmark one or more resources. The input is received by the user device as plaintext, encrypted, and transmitted across the network via encoded ciphertext and may include, for example, authentication information associated with an account assigned to the user and accessible via the credentialed system. Further, the earmarking about which the intention to earmark is regarding includes allocating the one or more resources to a credentialed location, such as a credentialed interest-bearing self-escrow account that is specific to the user and associated with the credentialed system.

According to various embodiments, the method 300 may also include receiving, by the credentialed system of the computer system and via the user interface of the user device, one or more additional inputs indicating an earmark goal of the user. Further, a graphical report may be generated to be displayed, via the user interface of the user device, where the graphical report depicts user progress toward the earmark goal. According to one embodiment, the generating of the graphical report is periodically repeated to produce an updated version of the graphical report that includes updated information. Further, the updated version of the graphical report is distributed, via an electronic notification, with the updated information. According to various embodiments, the electronic notification may be selected from the group consisting of a SMS text, an automated telephone message, an electronic mail, and a web push notification. Various other electronic communication methods are also contemplated and incorporated herein.

In some embodiments, the method 300 alternatively or additionally includes displaying, via the user interface of the user device, a plurality of credentialed location options, where the plurality of credentialed location options include the credentialed location. In some embodiments, the method 300 also includes creating, based on receiving the input from the user, the credentialed location (e.g., opening an interest-bearing self-escrow account) specific to the user and assigning a unique identification/account number to the credentialed location. In some embodiments, the method 300 also includes receiving, by the credentialed system and via a control input that is displayed via the user interface of the user device, an automatic distribution input from the user. The automatic distribution input may indicate a date at which a distribution is to be made to a third party using the earmarked one or more resources. Further, the method 300 may include distributing the earmarked one or more resources to the third party by the indicated date. In some embodiments, a current automatic distribution allocation associated with a current escrow amount (e.g., an amount that covers PMI, property taxes, property insurance) is reduced by a predetermined amount depending on the amount earmarked by the user. Specifically, the predetermined amount may correspond to the earmarked amount of the one or more resources that is to be allocated to the credentialed location. Further, rather than automatically distributing the current automatic distribution allocation, the credentialed system may automatically withdraw future payments from one or more pay period deposits and deposit one or more an earmarked amount to the credentialed location. In some embodiments, if a user so indicates, one or more previously escrowed resources deposited to a current escrow account (e.g., one that is non-interest bearing) may be withdrawn and transferred to the credentialed location specific to the user. For instance, if the user already has $10,000 deposited in a non-interest bearing escrow account when the user becomes eligible to qualify for the interest-bearing self-escrow account due to their principal balance on the mortgage reaches the threshold ratio, if the property taxes and property insurance are still not due for a few months then it might benefit the user to withdraw the $10,000 and transfer that amount to the interest-bearing self-escrow account in order to earn interest.

Further, according to various embodiments, additional reminder notifications may be distributed to remind users to pay their tax and insurance bills when they become due. These reminder notifications may be distributed according to a preset distribution schedule set by the user or may be automatically distributed at a time predicted to correlate to prior property tax and/or property insurance payments.

FIG. 4 depicts a block diagram of an example method 400 for earmarking via an encrypted session of a credentialed system, in accordance with an embodiment of the present invention. At block 405, it is determined that a user inputs one or more security credentials to access an encrypted session of a credentialed system associated with the user. At block 410, the credentialed system of the computing system transmits at least one notification to a user device being used to access the credentialed system, where the at least one notification is to be displayed via a user interface of the user device. Further, the at least one notification indicates one or more earmarking capabilities not currently utilized by the user. For instance, when a user logs in to their online account associated with the financial institution, the credentialed system may display the notification to the user indicating that the user is eligible to open an interest-bearing self-escrow account.

At block 415, the credentialed system receives, across a network and via a user interface of the user device, an input from the user indicating an intention to earmark one or more resources. For instance, the user may provide a plaintext input and the input is encrypted and transmitted across the network via encoded ciphertext. The earmarking includes allocating the one or more resources to a credentialed location (e.g., an interest-bearing self-escrow account) that is specific to the user and associated with the credentialed system. In some embodiments, the method 400 also includes receiving, by the credentialed system and via the user interface, one or more additional inputs indicating an earmark goal and generating a graphical report to be displayed, via the user interface that depicts user progress toward the earmark goal. In some embodiments, the credentialed system periodically repeats the generating of the graphical report with updated information and periodically distributes an updated version of the graphical report that includes the updated information, where the graphical report is distributed via an electronic notification. Further, in various examples, the electronic notification is selected from the group consisting of a SMS text, an automated telephone message, an electronic mail, and a web push notification. In some instances, the method 400 also includes displaying, via the user interface, a plurality of credentialed location options for the user to select, where the plurality of credentialed location options include the credentialed location. Further, based on receiving the input from the user, the credentialed system may create the credentialed location that is specific to the user and assigns a unique identification number to the credentialed location.

Computer program instructions are configured to carry out operations of the present invention and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to explain the principles of one or more aspects of the invention and the practical application thereof, and to enable others of ordinary skill in the art to understand one or more aspects of the invention for various embodiments with various modifications as are suited to the particular use contemplated.

It is to be noted that various terms used herein such as “Linux®”, “Windows®”, “macOS®”, “iOS®”, “Android®”, and the like may be subject to trademark rights in various jurisdictions throughout the world and are used here only in reference to the products or services properly denominated by the marks to the extent that such trademark rights may exist.

What is claimed is:

1. A computing system for event triggered earmarking via an encrypted session of a credentialed system, the system comprising:
at least one processor;
a communication interface communicatively coupled to the at least one processor; and
a memory device storing executable code that, when executed, causes the at least one processor to:
identify an event associated with a threshold ratio, wherein the event enables a user to qualify for one or more previously inaccessible earmarking capabilities, the event triggering at least one notification to be issued via the credentialed system;
determine that the user inputs one or more security credentials to access the encrypted session of the credentialed system associated with the user;
transmit, via the credentialed system, the at least one notification to a user device being used to access the credentialed system, the at least one notification to be displayed via a user interface of the user device, the at least one notification indicating that the user qualifies for the one or more previously inaccessible earmarking capabilities; and
receive, across a network by the credentialed system and via a user interface of the user device, an input from the user indicating an intention to earmark one or more resources, wherein the input is received by the user device as plaintext, encrypted and transmitted across the network via encoded ciphertext, the earmarking including allocating the one or more resources to a credentialed location specific to the user and associated with the credentialed system.

2. The computing system for event triggered earmarking via an encrypted session of a credentialed system of claim 1, wherein the event associated with the threshold ratio comprises an equity value of real property reaching at least twenty percent.

3. The computing system for event triggered earmarking via an encrypted session of a credentialed system of claim 1, wherein the executable code further causes the at least one processor to:
receive, by the credentialed system and via the user interface, one or more additional inputs indicating an earmark goal; and
generate a graphical report to be displayed, via the user interface, which depicts user progress toward the earmark goal.

4. The computing system for event triggered earmarking via an encrypted session of a credentialed system of claim 3, wherein the executable code further causes the at least one processor to periodically repeat the generating of the graphical report with updated information and periodically distribute an updated version of the graphical report with the updated information via an electronic notification.

5. The computing system for event triggered earmarking via an encrypted session of a credentialed system of claim 4, wherein the electronic notification is selected from the group consisting of a SMS text, an automated telephone message, an electronic mail, and a web push notification.

6. The computing system for event triggered earmarking via an encrypted session of a credentialed system of claim 1, wherein the credentialed location includes an interest bearing account.

7. The computing system for event triggered earmarking via an encrypted session of a credentialed system of claim 1, wherein the executable code further causes the at least one processor to:
display, via the user interface, a plurality of credentialed location options for the user to select, the plurality of credentialed location options including the credentialed location; and
based on receiving the input from the user, create the credentialed location specific to the user and assigning a unique identification number to the credentialed location.

8. The computing system for event triggered earmarking via an encrypted session of a credentialed system of claim 1, wherein the executable code further causes the at least one processor to:
receive, by the credentialed system and via the user interface, an automatic distribution input from the user indicating a date at which a distribution to a third party is made using the earmarked one or more resources; and
distributing, to the third party, the earmarked one or more resources by the indicated date.

9. The computing system for event triggered earmarking via an encrypted session of a credentialed system of claim 1, wherein the executable code further causes the at least one processor to reduce a current automatic distribution allocation by a predetermined amount corresponding to an earmarked amount of the one or more resources.

10. The computing system for event triggered earmarking via an encrypted session of a credentialed system of claim 1, wherein the executable code further causes the at least one processor to withdraw one or more escrowed resources and transferring the one or more escrowed resources to the credentialed location specific to the user.

11. A computing system for earmarking via an encrypted session of a credentialed system, the system comprising:
at least one processor;
a communication interface communicatively coupled to the at least one processor; and
a memory device storing executable code that, when executed, causes the at least one processor to:
determine that a user inputs one or more security credentials to access the encrypted session of the credentialed system associated with the user;
transmit, via the credentialed system, at least one notification to a user device being used to access the credentialed system, the at least one notification to be displayed via a user interface of the user device, the at least one notification indicating one or more earmarking capabilities not currently utilized by the user; and
receive, across a network by the credentialed system and via a user interface of the user device, an input from the user indicating an intention to earmark one or more resources, wherein the input is received by the user device as plaintext, encrypted and transmitted across the network via encoded ciphertext, the earmarking including allocating the one or more resources to a credentialed location specific to the user and associated with the credentialed system.

12. The computing system of claim 11 for earmarking via an encrypted session of a credentialed system, wherein the executable code further causes the at least one processor to:
receive, by the credentialed system and via the user interface, one or more additional inputs indicating an earmark goal; and
generate a graphical report to be displayed, via the user interface, which depicts user progress toward the earmark goal.

13. The computing system of claim 12 for earmarking via an encrypted session of a credentialed system, wherein the executable code further causes the at least one processor to periodically repeat the generating of the graphical report with updated information and periodically distribute an updated version of the graphical report with the updated information via an electronic notification.

14. The computing system of claim 13 for earmarking via an encrypted session of a credentialed system, wherein the electronic notification is selected from the group consisting of a SMS text, an automated telephone message, an electronic mail, and a web push notification.

15. The computing system of claim 11 for earmarking via an encrypted session of a credentialed system, wherein the credentialed location includes an interest bearing account.

16. The computing system of claim 11 for earmarking via an encrypted session of a credentialed system, wherein the executable code further causes the at least one processor to:
display, via the user interface, a plurality of credentialed location options for the user to select, the plurality of credentialed location options including the credentialed location; and
based on receiving the input from the user, create the credentialed location specific to the user and assigning a unique identification number to the credentialed location.

17. A computer-implemented method for event triggered earmarking via an encrypted session of a credentialed system, the method comprising:
identifying an event associated with a threshold ratio, wherein the event enables a user to qualify for one or more previously inaccessible earmarking capabilities, the event triggering at least one notification to be issued via the credentialed system;
determining that the user inputs one or more security credentials to access the encrypted session of the credentialed system associated with the user;
transmitting, via the credentialed system, the at least one notification to a user device being used to access the credentialed system, the at least one notification to be displayed via a user interface of the user device, the at least one notification indicating that the user qualifies for the one or more previously inaccessible earmarking capabilities; and
receiving, across a network by the credentialed system and via a user interface of the user device, an input from the user indicating an intention to earmark one or more resources, wherein the input is received by the user device as plaintext, encrypted and transmitted across the network via encoded ciphertext, the earmarking including allocating the one or more resources to a credentialed location specific to the user and associated with the credentialed system.

18. The computer-implemented method for event triggered earmarking via an encrypted session of a credentialed system of claim 17, wherein the event associated with the threshold ratio comprises an equity value of real property reaching at least twenty percent.

19. The computer-implemented method for event triggered earmarking via an encrypted session of a credentialed system of claim 17, wherein the method further includes receiving, via the user interface, one or more additional inputs indicating an earmark goal, and generating a graphical report to be displayed, via the user interface, that depicts user progress toward the earmark goal.

20. The computer-implemented method for event triggered earmarking via an encrypted session of a credentialed system of claim 17, wherein the method further includes:
displaying, via the user interface, a plurality of credentialed location options for the user to select, the plurality of credentialed location options including the credentialed location; and
based on receiving the input from the user, creating the credentialed location specific to the user and assigning a unique identification number to the credentialed location.
